(19) United States
(12) Patent Application Publication
(10) Pub. No.: US 2019/0217749 A1
(43) Pub. Date: Jul. 18, 2019

(54) VEHICLE SEAT

(71) Applicant: TOYOTA BOSHOKU KABUSHIKI KAISHA, Aichi-ken (JP)

(72) Inventors: Yasuhiro KATO, Aichi-ken (JP); Hiroshi MIZOBATA, Aichi-ken (JP)

(73) Assignee: TOYOTA BOSHOKU KABUSHIKI KAISHA, Aichi-ken (JP)

(21) Appl. No.: 16/250,433

(22) Filed: Jan. 17, 2019

(30) Foreign Application Priority Data
Jan. 18, 2018 (JP) 2018-006368
Jan. 18, 2018 (JP) 2018-006372
Jan. 18, 2018 (JP) 2018-006376

(51) Int. Cl. B60N 2/20; B60N 2/68

(52) U.S. Cl. CPC B60N 2/20; B60N 2/682

(57) ABSTRACT

A vehicle seat including: a reclining plate; a lower arm whose rear region is coupled to the reclining plate; a leg supporting the lower arm; a reinforcing member coupled to the lower arm and reinforcing the lower arm; and a bolt fastening portion including a bolt which penetrates through the reclining plate and the lower arm in a seat width direction to fasten the reclining plate and the lower arm, wherein the reinforcing member includes: a co-fastening portion into which the bolt of the bolt fastening portion is inserted in the seat width direction so as to be fastened together with the reclining plate and the lower arm; a coupling portion coupled to a general surface portion of the lower arm which is positioned out of the co-fastening portion; and a load transmission portion configured to directly transmit a load input to the co-fastening portion to the coupling portion.

### CROSS-REFERENCE TO RELATED APPLICATIONS

This application claims priority from Japanese Patent Application No. 2018-006368 filed on Jan. 18, 2018, Japanese Patent Application No. 2018-006372 filed on Jan. 18, 2018, and Japanese Patent Application No. 2018-006376 filed on Jan. 18, 2018, the entire contents of which are incorporated herein by reference.

### TECHNICAL FIELD

The disclosure relates to a vehicle seat. In particular, an aspect of the disclosure relates to a vehicle seat including a reclining plate connected to a recliner serving as a seat reclining adjustment mechanism and a lower arm serving as a side frame of a seat cushion, where a rear region of the lower arm is coupled to the reclining plate. Further, another aspect of the disclosure relates to a vehicle seat including a frame member having a plurality of insertion holes into which a plurality of shaft portions of a plurality of bolts are respectively inserted, and a plurality of collar portions which are respectively aligned with the plurality of insertion holes of the frame member and through which the plurality of shaft portions of the plurality of bolts respectively passes.

### BACKGROUND

Related art discloses a vehicle seat having a structure in which a reclining plate for tiltably supporting a seat back is fastened by a bolt and fixed to a rear end portion of a lower arm constituting a side frame of a seat cushion (JP-A-2009-202788).

In the above related art, there is a concern that an excessive load accompanied by local deformation is input to a fastening portion of the lower arm to the reclining plate when an excessive load due to a vehicle collision or the like is input to a seat back.

Another related art discloses a vehicle seat having a structure in which a seat frame is fastened to another frame by a plurality of bolts (JP-A-2017-081489). Specifically, collars for passing through the shaft portions of the bolts are provided between the seat frame and the other frame, and the seat frame and the other frame are fastened via these collars in a state of being supported so as not to be crushed against each other in an axial direction.

In the above related art, the collars are needed to be set between the seat frame and the other frame in a state of being separately aligned, with the seat frame and the other frame, which results in bad assembling property.

### SUMMARY

An object to be achieved by an aspect of the disclosure is to appropriately disperse and receive a load which is input to a lower arm of a seat cushion from a seat back via a reclining plate.

Another object to be achieved by another aspect of the disclosure is to appropriately disperse and escape a load which is input to a lower arm of a seat cushion from a seat back via a reclining plate.

Another object to be achieved by the disclosure is to improve the assembling property of collars set to a frame member of a vehicle seat.

According to an aspect of the disclosure, there is provided a vehicle seat including: a reclining plate connected to a recliner serving as a seat reclining adjustment mechanism; a lower arm serving as a side frame of a seat cushion, a rear region of the lower arm being coupled to the reclining plate; a leg supporting the lower arm in a state where the lower arm is raised with respect to a base on a floor; a reinforcing member coupled to the lower arm and reinforcing the lower arm; and a bolt fastening portion including a bolt which penetrates through the reclining plate and the lower arm in a seat width direction to fasten the reclining plate and the lower arm, wherein the reinforcing member includes: a co-fastening portion into which the bolt of the bolt fastening portion is inserted in the seat width direction so as to be fastened together with the reclining plate and the lower arm; a coupling portion coupled to a general surface portion of the lower arm which is positioned out of the co-fastening portion; and a load transmission portion configured to directly transmit a load input to the co-fastening portion to the coupling portion.

Accordingly, the load transmitted from the reclining plate to the lower arm via the bolt fastening portion can be appropriately dispersed and received over a wide range of the lower arm by the reinforcing member.

According to another aspect of the disclosure, there is provided a vehicle seat including: a reclining plate connected to a recliner serving as a seat reclining adjustment mechanism; a lower arm serving as a side frame of a seat cushion, a rear region of the lower arm being coupled to the reclining plate; a front leg and a rear leg supporting the lower arm in a state where the lower arm is raised with respect to a base on a floor at two positions in a front and rear direction; and a pin joining portion including a single shaft member which penetrates through the rear leg and the reclining plate in a seat width direction to join the rear leg and the reclining plate in a relatively rotatable manner.

Accordingly, the load transmitted from the reclining plate to the lower arm can be transmitted to the support point by the front leg by the rotation of the lower arm around the pin joining portion between the reclining plate and the rear leg, and the load input to the lower arm can be appropriately dispersed and escaped.

According to an another aspect of the disclosure, there is provided a vehicle seat including: a frame member having a plurality of insertion holes into which a plurality of shaft portions of a plurality of bolts are respectively inserted; and a plurality of collar portions which are respectively aligned with the plurality of insertion holes of the frame member and through which the plurality of shaft portions of the plurality of bolts respectively passes, wherein the plurality of collar portions is configured as a collar body which is a single component and in which the collar portions are joined with each other into one piece.

Accordingly, the plurality of collar portions through which the plurality of shaft portions of the plurality of bolts inserted into the frame member respectively passes are configured as the collar body which is a single component and in which the collar portions are joined with each other into one piece. In this way, the collar portions can be collectively positioned, thereby improving the assembling property.

### BRIEF DESCRIPTION OF DRAWINGS

FIG. 1 is a perspective view showing a schematic configuration of a vehicle seat according to a first embodiment;

FIG. 2 is an enlarged perspective view of a main part of FIG. 1;

FIG. 3 is an enlarged perspective view of FIG. 2 as viewed from the opposite side;

FIG. 4 is a side view of FIG. 2;

FIG. 5 is an exploded perspective view of FIG. 2;

FIG. 6 is an exploded perspective view of FIG. 3;

FIG. 7 is a perspective view of FIG. 2 as viewed from the rear side;

FIG. 8 is a sectional view taken along the line VIII-VIII in FIG. 4;

FIG. 9 is a sectional view taken along the line IX-IX in FIG. 4; and

FIG. 10 is a side view showing the load transmission when a large load in a forward direction is input to a seat back from FIG. 4.

### DETAILED DESCRIPTION

Hereinafter, an embodiment for carrying out the disclosure will be described with reference to the drawings.

### First Embodiment

<Basic Configuration of Seat 1>

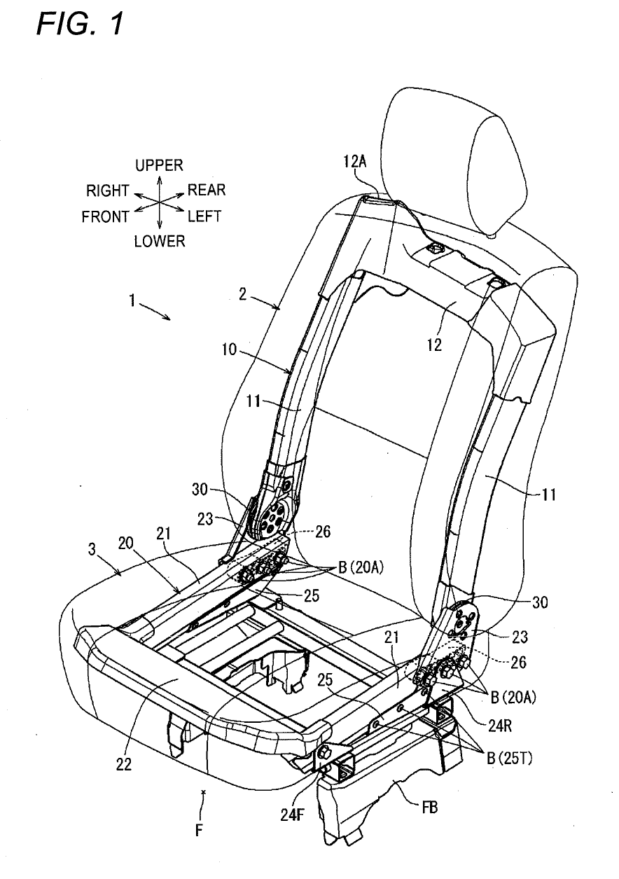

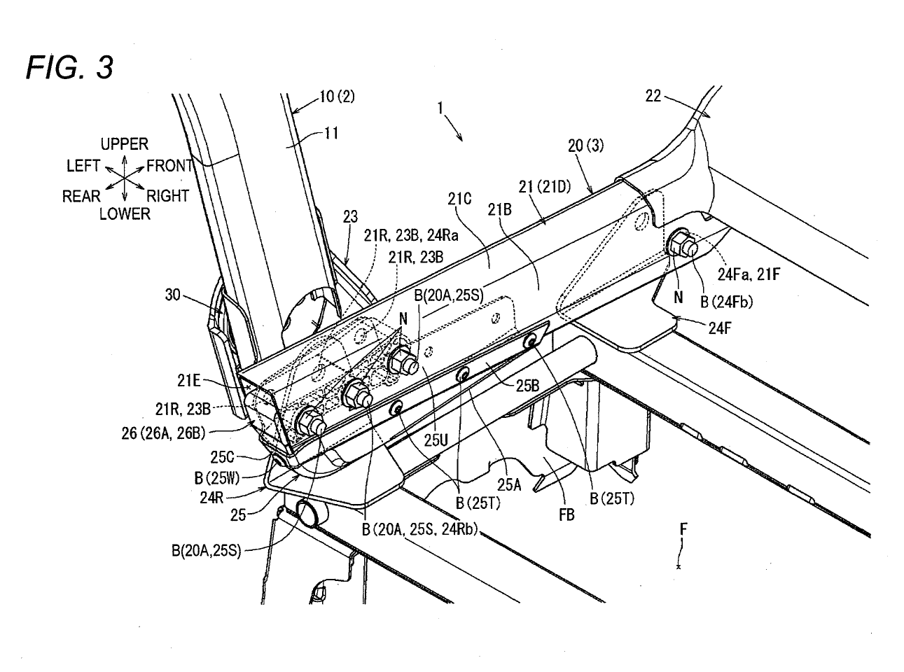

First, a configuration of a seat 1 according to a first embodiment will be described with reference to FIGS. 1 to 10. Meanwhile, in the following description, the directions such as a front and rear direction, an upper and lower direction and a right and left direction refer to the respective directions as indicated in each of the drawings. Further, the “seat width direction” refers to the right and left direction of the seat 1, and the “seat front and rear direction” refers to the front and rear direction of the seat 1.

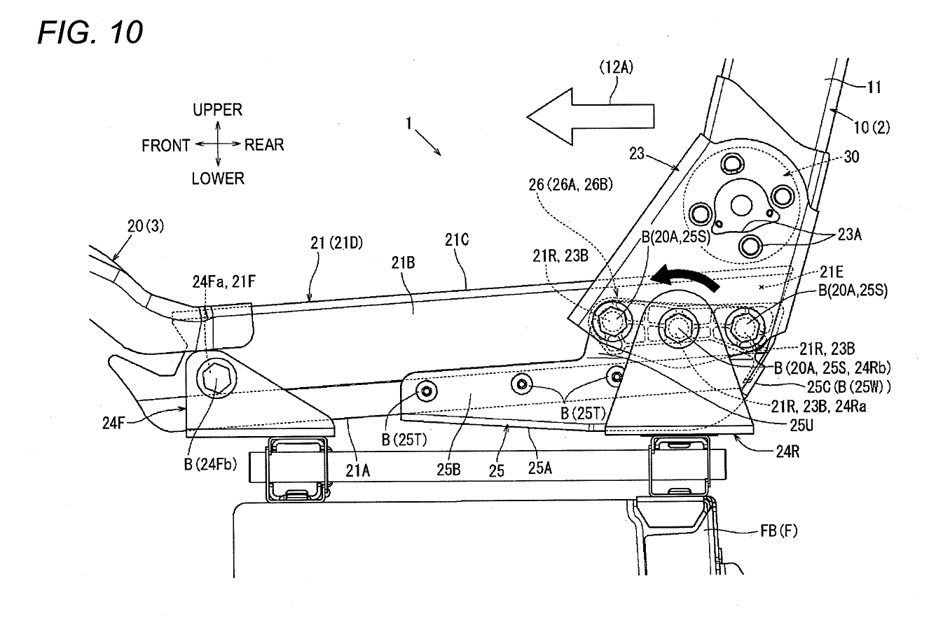

As shown in FIG. 1, the seat 1 of the present embodiment is configured as a right seat of an automobile. The seat 1 includes a seat back 2 serving as a backrest of a seated person and a seat cushion 3 serving as a seating part. The seat 1 is configured as a so-called belt-in seat. In the seat 1, a retractor of a seat belt (not shown) is incorporated in a back portion of the seat back 2, and a pull-out port 12A of the seat belt is set in a shoulder mouth portion on the right side of the seat back 2. With this configuration, as shown in FIG. 10, when a front collision of a vehicle occurs, a tensile load toward the front side due to the seat belt (not shown) receiving a body of a seated person is applied to the shoulder mouth portion of the seat back 2 where the pull-out port 12A is set.

As shown in FIG. 1, lower end portions on both right and left sides of the seat back 2 are respectively connected to rear end portions on both right and left sides of the seat cushion 3 via recliners 30 serving as a seat reclining adjustment mechanism in a state where a backrest angle can be adjusted. The seat cushion 3 is connected to a base FB installed on a vehicle floor F in a raised state in a height direction via a pair of front and rear legs 24F, 24R (to be described later) on the right and left sides, respectively. Meanwhile, a specific configuration of each recliner 30 described above is substantially the same as a known configuration disclosed in a literature such as JP-A-2015-029635, and a detailed description thereof will be omitted.

<Configuration of Seat Back 2>

Specifically, the seat back 2 mainly includes a metallic back frame 10 serving as a framework of the seat back, an urethane foam back pad (not shown) set in the front portion of the back frame 10 and elastically receiving the backrest load of the seated person, and a fabric back cover (not shown) covered on the entire surface of the back pad and forming a design surface of the seat back 2.

The back frame 10 has a structure assembled into a substantially inverted U shape in a front view and includes vertically elongated side frames 11 serving as a side framework on both right and left sides of the seat back 2, and an upper frame 12 integrally bridged between the upper portions of the side frames 11 and serving as an upper framework of the seat back 2. Further, although not shown, a reinforcing material for enhancing the structural strength of the back frame 10 is integrally bridged between the side frames 11 of the back frame 10.

Furthermore, a contour mat (not shown) for elastically supporting the central portion of the back pad (not shown) in a planar shape from the rear side is bridged between the upper frame 12 of the back frame 10 and the reinforcing material (not shown). Further, the pull-out port 12A of the seat belt is set in the shoulder mouth portion on the right side of the upper frame 12.

<Configuration of Seat Cushion 3>

Similar to the seat back 2, the seat cushion 3 mainly includes a metallic cushion frame 20 serving as a framework of the seat cushion, an urethane foam cushion pad (not shown) set in the upper portion of the cushion frame 20 and elastically receiving the load of the seated person, and a fabric cushion cover (not shown) covered on the entire surface of the cushion pad and forming a design surface of the seat cushion 3.

The cushion frame 20 has a structure assembled into a substantially U shape in a plan view and includes lower arms 21 serving as a side framework on both right and left sides of the seat cushion 3 and extending elongated in a front and rear direction, and a front panel 22 integrally bridged between the front portions of the lower arms 21 and serving as a front framework of the seat cushion 3. Further, although not shown, a reinforcing material for enhancing the structural strength of the cushion frame 20 is integrally bridged between the lower arms 21 of the cushion frame 20. Furthermore, a metallic cushion pan (not shown) for elastically supporting the central portion of the cushion pad (not shown) in a planar shape from the lower side is bridged between the front panel 22 of the cushion frame 20 and the reinforcing material (not shown). Here, each of the lower arms described above corresponds to the “frame member” in the disclosure.

A reclining plate 23 is connected to a lower end portion of the side frame 11 on each side of the seat back 2 via the recliner 30 and joined to a rear end portion of each lower arm 21 of the cushion frame 20, respectively. These reclining plates 23 are made of a steel plate thicker than each lower arm 21 and are configured to have a high structural strength capable of strongly receiving loads such as bending and torsion input from the seat back 2 via the recliner 30 on each side.

The cushion frame 20 is connected to the base FB installed on the vehicle floor F in a raised state via a pair of front and rear legs 24F, 24R on the right and left sides, respectively. Further, a reinforcing member 25 for widely dispersing and strongly receiving the loads such as bending and torsion input from the reclining plate 23 on each side is joined to each lower arm 21 of the cushion frame 20, respectively. These reinforcing members 25 are made of CFRP (carbon fiber-reinforced plastic) having a higher specific strength than each lower arm 21 and each reclining plate 23 and are configured to have a high structural strength capable of transmitting the loads such as bending and torsion input to the reclining plates 23 to the lower arms 21 in a widely dispersed manner.

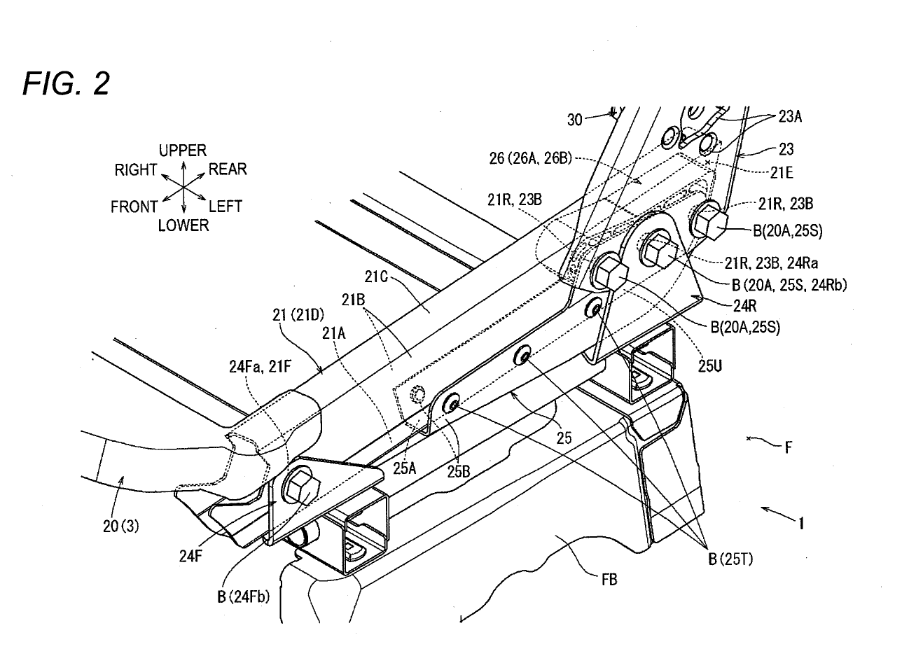

As shown in FIG. 2, the coupling between each reclining plate 23 and each lower arm 21 is performed by fastening a plurality of bolts B inserted therethrough in the seat width direction, respectively (bolt fastening portion 20A). In each of the bolt fastening portions 20A between the reclining plates 23 and the lower arms 21, a collar body 26 which collectively has a plurality of collar portions 26A is provided in a closed sectional portion 21D of each lower arm 21. Each of the plurality of collar portions 26 is provided with a through-hole 26B through which each bolt B passes.

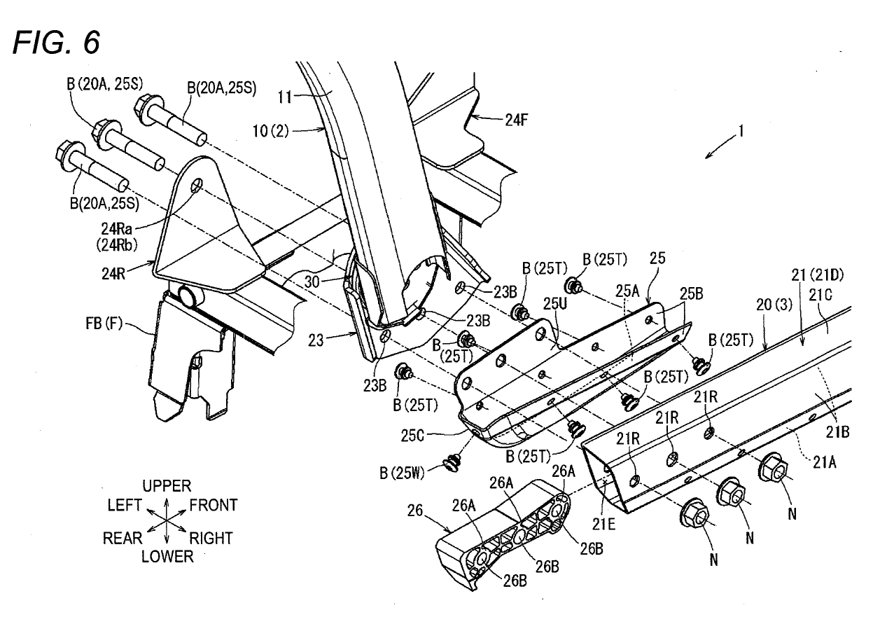

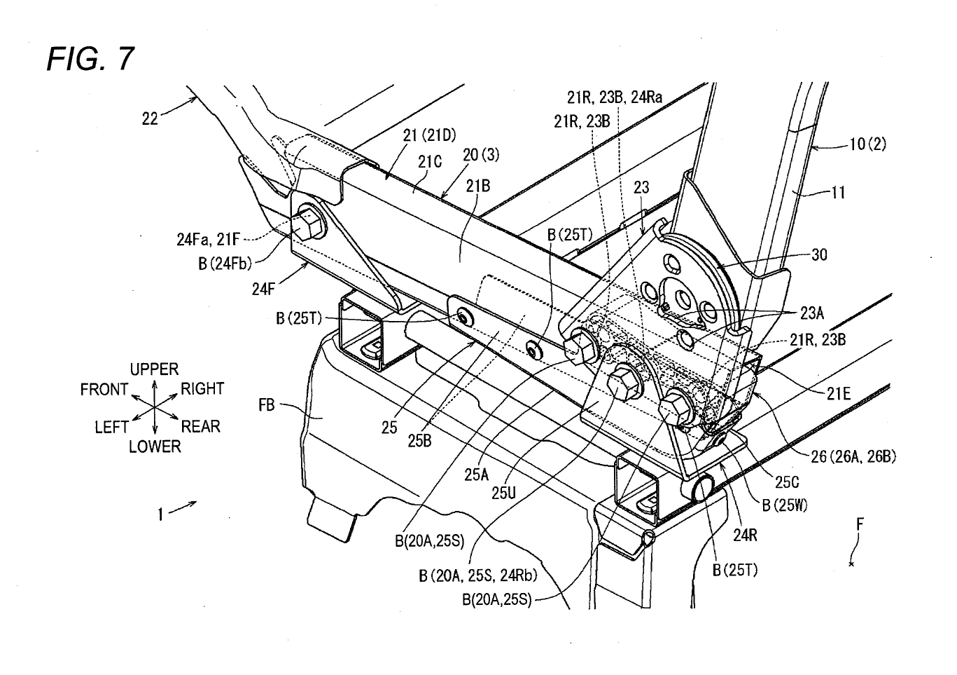

As shown in FIGS. 6 and 7, each of the collar bodies 26 is set by being inserted into the closed sectional portion 21D of each lower arm 21 formed by a square pipe material having a substantially rectangular section from a rear opening portion 21E. Each of the collar bodies 26 collectively has a plurality of through-holes 26B through which the bolts B pass. Therefore, it is possible to conveniently set the collar portions 26A collectively without individually setting the collar portion 26A. Further, the loads such as bending and torsion transmitted from the respective bolts B passed through the respective through-holes 26B can be widely dispersed in the collar body 26 having an integral structure and can be transmitted to the lower arm 21 on each side.

Hereinafter, a specific configuration of each part of the cushion frame 20 will be described in detail. That is, as shown in FIGS. 2 to 7, each lower arm 21 is formed of a square pipe material which has a substantially rectangular vertically-elongated hollow sectional shape and which extends in a straight shape in the seat front and rear direction. Specifically, each lower arm 21 is formed of an extruded aluminum material. Each lower arm 21 has the constant sectional shape described above and is formed to extend in the straight shape in the seat front and rear direction.

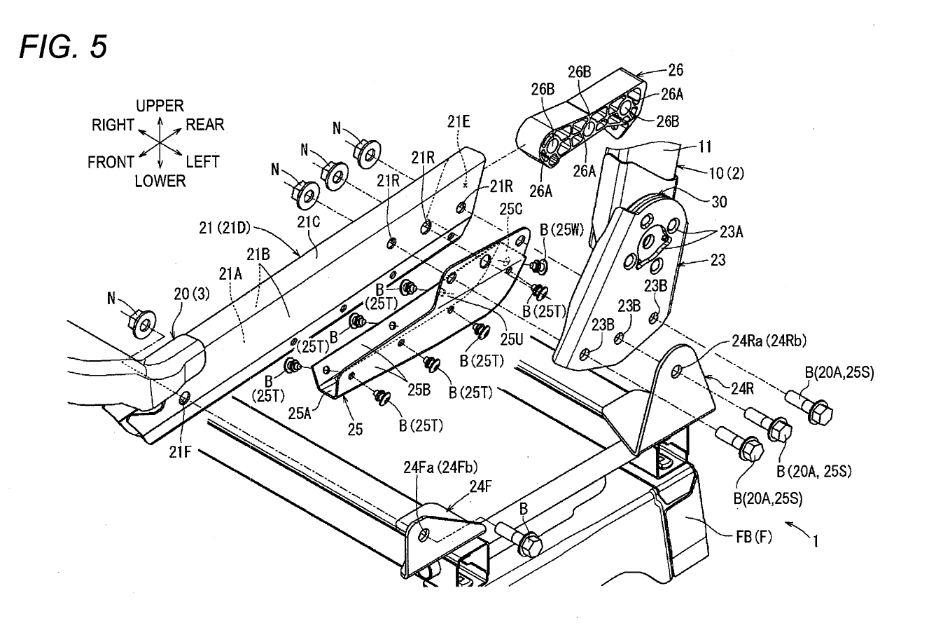

As shown in FIG. 2 and FIGS. 4 to 6, each reclining plate 23 is formed of a thick steel plate material cut into a substantially triangular shape in a side view. As shown in FIG. 5, fitting through-holes 23A which are fitted with the outer portion of each recliner 30 are formed on the upper region of each reclining plate 23. Further, round holes 23B are formed at three positions in the seat front and rear direction on the lower region of each reclining plate 23. The round holes 23B are aligned with three round holes 21R formed at a rear region of each lower arm 21 and penetrating in the seat width direction from the outside in the seat width direction. The bolts B are inserted and fastened through the round holes 23B and the round holes 21R.

The outer portion of each recliner 30 is fitted into the fitting holes 23A before each reclining plate 23 is joined with each lower arm 21, so that each reclining plate 23 is integrally joined with each recliner 30 by welding. With this coupling, each reclining plate 23 is brought into a fastening operation process with each lower arm 21 by the bolts B as a state of being attached to the back frame 10 via each recliner 30.

Then, in the above-described fastening operation process, in a state where the reclining plates 23 are integrated with each other via the back frame 10, each reclining plate 23 is set so that the round holes 23B are aligned with the corresponding round holes 21R of each lower arm 21 from the outside in the seat width direction, and the bolts B are inserted and fastened so as to penetrate the aligned round holes 23B, 21R from the outside in the seat width direction (bolt fastening portion 20A).

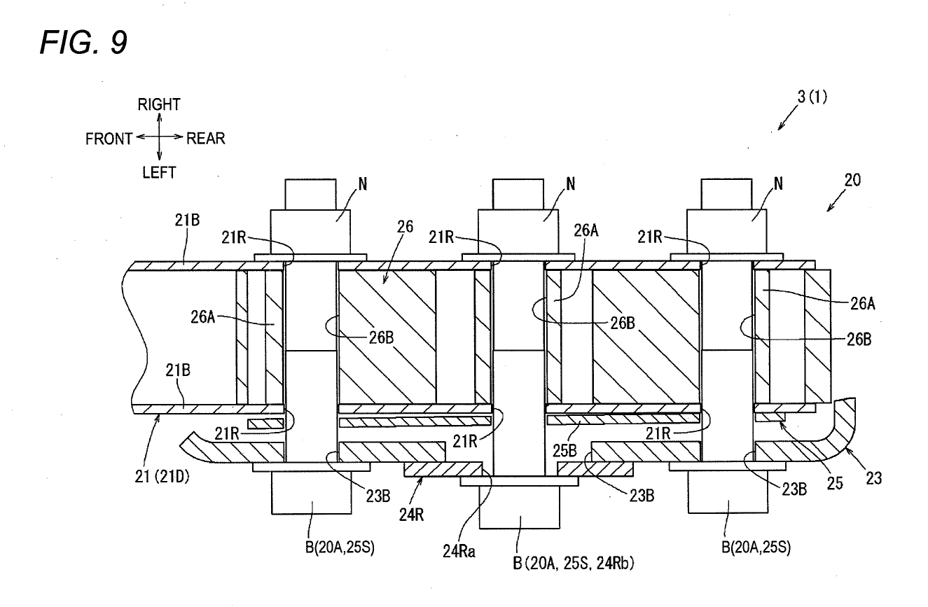

At that time, among three bolts B inserted through each reclining plate 23 and each lower arm 21, the bolt B inserted at the center is also inserted into a round hole 24Ra formed in an upper end portion of each rear leg 24R, and each rear leg 24R is also fastened to each reclining plate 23 and each lower arm 21 in a state of being fastened together (pin joining portion 24Rb). With this fastening, each rear leg 24R is superimposed on the outer portion of each reclining plate 23 in the seat width direction and is integrally connected to each reclining plate 23 and each lower arm 21 (see FIG. 9). Here, each bolt B inserted at the center and constituting the pin joining portion 24Rb corresponds to the “shaft member” in the disclosure.

Each front leg 24F is set so that a round hole 24Fa formed at the upper end portion thereof is aligned with a round hole 21F formed in the front portion of each lower arm 21 and penetrating in the seat width direction from the outside in the seat width direction, and the bolt B is inserted and fastened so as to penetrate the aligned round holes 24Fa, 21F from the outside in the seat width direction. In this way, each front leg 24F is superimposed on the outer portion of the lower arm 21 on each side in the seat width direction and is integrally connected to each lower arm 21 (pin joining portion 24Fb).

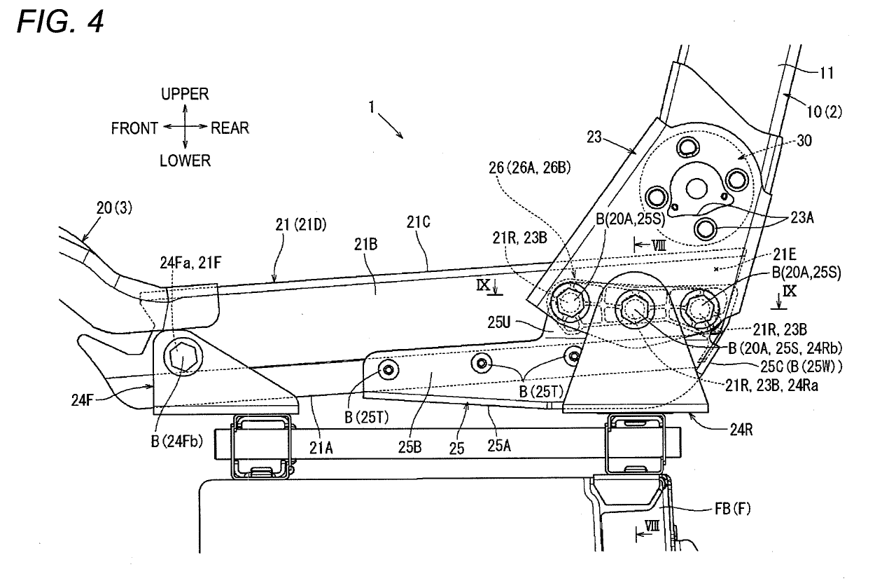

As shown in FIGS. 1 and 4, each front leg 24F and each rear leg 24R described above are provided in a state where lower ends thereof are integrally joined to the base FB installed on the vehicle floor F. For example, due to a seat belt (not shown) receiving a body of a seated person when a front collision of a vehicle occurs, a load of bending moment in the forward turn direction around a supporting point on the lower end side is input to the seat back 2. With the above coupling, as shown in FIG. 10, the cushion frame 20 is configured such that the load of bending moment is transmitted, as a rotational force around the pin joining portion 24Rb serving as a connection point between each reclining plate 23 and each rear leg 24R by the bolts B, along the lower arm 21 on each side and transmitted to a support structure by the front legs 24F. With this transmission, the load of bending moment transmitted from the reclining plates 23 to the lower arms 21 are appropriately dispersed and received over a wide range of the lower arms 21.

As shown in FIGS. 2 to 8, each reinforcing member 25 is formed in a curved plate shape and has a plate-like bottom surface covering portion 25A covering a bottom surface portion 21A of each lower arm 21 and extending elongated in the seat front and rear direction, standing plate-like both side surface covering portions 25B standing from both right and left edges of the bottom surface covering portion 25A and covering the both side surface portions 21B of each lower arm 21, and a standing plate-like rear surface covering portion 25C standing from a rear edge of the bottom surface covering portion 25A so as to connect rear edges of the both side surface covering portions 25B and covering the opening portion on the rear end side of each lower arm 21 from the rear side. Each reinforcing member 25 does not cover an upper surface portion 21C of each lower arm 21.

In each reinforcing member 25, as coupling portions 25T, the upper regions of the both side surface covering portions 25B are brought into surface contact with the lower regions of the both side surface portions 21B of each lower arm 21 from both sides in the seat width direction. The bolts B are inserted at a plurality of contact positions in the seat front and rear direction from both sides in the seat width direction, so that the reinforcing members 25 and the lower arms 21 are integrally fastened. Here, the both side surface portions 21B of each lower arm 21 correspond to the “general surface portion” in the disclosure.

Further, as shown in FIGS. 2 and 4, a rear-side portion of the side surface covering portion 25B of each reinforcing member 25 partially extends elongated upward so as to serve as a co-fastening portion 25S. The side surface covering portion 25B of each reinforcing member 25 comes into contact with the side surface 21B of each lower arm 21 on the outer side in the seat width direction. The three bolts B penetrating through each reclining plate 23 and each lower arm 21 are passed through each co-fastening portion 25S, so that the reclining plates 23 and the lower arms 21 are integrally fastened. With this fastening, the co-fastening portion 25S of each reinforcing member 25 is superimposed on the outer portion in the seat width direction of each lower arm 21, so that the reclining plates 23 and the lower arms 21 are integrally connected.

Furthermore, as shown in FIGS. 6 and 7, a part of the rear surface covering portion 25C of each reinforcing member 25 covering the opening portion 21E on the rear end side of each lower arm 21 serves as a rear surface coupling portion 25W. The rear surface coupling portion 25W is brought into surface contact with a rear surface portion of each collar body 26 exposed from the opening portion of each lower arm 21, and the bolt B is inserted to the contact portion from the rear side. In this way, the rear surface coupling portion 25W and the rear surface portion of each collar body 26 are integrally fastened. With this fastening, the rear surface covering portion 25C of each reinforcing member 25 is also fastened integrally with each lower arm 21 via each collar body 26.

When the load of bending moment from the seat back 2 is input to each reclining plate 23 as described in FIG. 1, each reinforcing member 25 fastened as described above receives the load from each reclining plate 23 at the co-fastening portion 25S fastened with each reclining plate 23 by the bolt B and the rear surface coupling portion 25W fastened with each collar body 26 by the bolt B as described in FIG. 7. Further, as shown in FIG. 10, the load received respectively at the co-fastening portion 25S and the rear surface coupling portion 25W of each reinforcing member 25 is transmitted along a load transmission portion 25U connecting each lower arm 21 and the coupling portions 25T serving as another coupling portion with each lower arm 21 and is directly transmitted to each coupling portion 25T, so that the load can be widely dispersed and received in each lower arm 21.

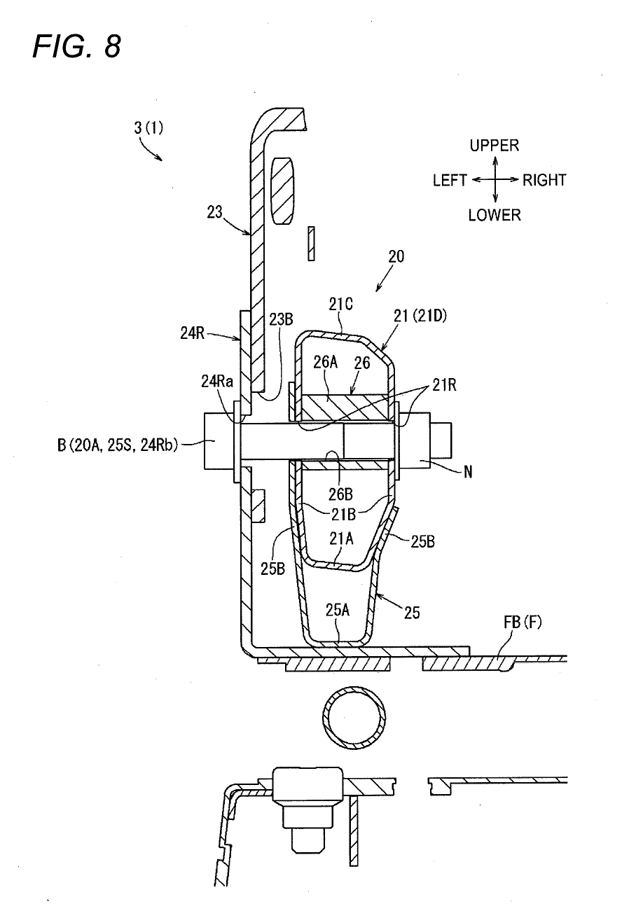

At that time, as described in FIG. 10, even when the cushion frame 20 receives the load as a load of the forward rotation around the pin joining portion 24Rb between each reclining plate 23 and each rear leg 24R, each reinforcing member 25 can receive the load in a widely dispersed manner so that the deformation of each lower arm 21 caused by the load of the forward rotation can be appropriately suppressed. Specifically, as shown in FIG. 8, the bottom surface covering portion 25A of each reinforcing member 25 is separated downward from the bottom surface portion 21A of each lower arm 21, and the entire height shape of the side frame combined with each lower arm 21 is increased downward.

With the above configuration, each reinforcing member 25 is configured such that the structural strength (geometrical moment of inertia (section modulus) around the pin joining portion 24Rb previously described in FIG. 10) against the entire bending moment of the side frame combined with each lower arm 21 is effectively enhanced. Specifically, each reinforcing member 25 has the rear surface coupling portion 25W at which the rear surface covering portion 25C standing from the rear end portion of the reinforcing member 25 as described in FIG. 7 is fastened to the rear surface portion of each collar body 26 exposed from the opening portion on the rear end side of each lower arm 21. Therefore, even when each lower arm 21 receives such a load that the rear end portion thereof is pulled upward by the action of the bending moment, it is possible to appropriately suppress the upward warping of the rear end portion of each lower arm 21 by the support of the rear surface coupling portion 25W.

Further, as shown in FIG. 8, each reinforcing member 25 is provided such that the both side surface covering portions 25B thereof sandwiches the both side surface portions 21B of each lower arm 21 in the seat width direction in a state of being connected to the bottom surface covering portion 25A and the rear surface covering portion 25C (see FIG. 7) and having high bending rigidity or torsional rigidity. In this way, even when each lower arm 21 tends to be bent in such a manner that the both side surface portions 21B protrude to both sides in the seat width direction under the load of the bending moment previously described in FIG. 10, it is possible to appropriately receive and suppress the deformation of each lower arm.

As shown in FIGS. 6 and 7, each collar body 26 is inserted into the closed sectional portion 21D of each lower arm 21 from the opening portion on the rear end side, and the corresponding through-holes 26B formed to penetrate through each collar portion 26A are set to be aligned with the round holes 21R formed to penetrate through the both side surface portions 21B of each lower arm 21. Each collar body 26 is configured by a single part having a constant sectional shape in the seat width direction which is the penetration direction of each through-hole 26B. Specifically, each collar body 26 is formed of an aluminum material extruded to have a constant sectional shape in the seat width direction. Each collar body 26 is configured as a single component in which the through-holes 26B are also formed to have a constant sectional shape in the seat width direction by the above extrusion molding. Here, each of the round holes described above corresponds to the “insertion hole” in the disclosure.

Each collar body 26 is set in the closed sectional portion 21D of each lower arm 21 as described above, and then, as shown in FIGS. 8 and 9, the bolts B are inserted through the through-holes 26B of each collar body 26. In this way, the attachment position of each collar body 26 to each lower arm 21 is fixed via the bolts B. Further, the bolts B passed through each collar body 26 are inserted through each lower arm 21 and fastened with nuts N at its tip ends. In this way, each collar body 26 supports the both side surface portions 21B from the inside so that the both side surface portions 21B of each lower arm 21 are not crushed by an axial compressive force generated between heads of the bolts B and the nuts N. Here, the both side surface portions of each lower arm described above correspond to the “facing portions” in the disclosure.

### SUMMARY

To summarize the above, the seat 1 of the present embodiment has the following configurations. That is, the vehicle seat (1) includes: the reclining plate (23) connected to the recliner (30) serving as a seat reclining adjustment mechanism; and the lower arm (21) serving as the side frame of the seat cushion (3). A rear region of the lower arm (21) is coupled to the reclining plate (23).

The vehicle seat (1) includes: the leg (24F, 24R) configured to support the lower arm (21) in a state where the lower arm (21) is raised with respect to the base (FB) on the floor (F); the reinforcing member (25) coupled to the lower arm (21) and reinforcing the lower arm (21); and the bolt fastening portion (20A) including the bolt (B) which penetrates through the reclining plate (23) and the lower arm (21) in the seat width direction to fasten the reclining plate (23) and the lower arm (21). The reinforcing member (25) includes: the co-fastening portion (25S) into which the bolt (B) of the bolt fastening portion (20A) is inserted in the seat width direction so as to be fastened together with the reclining plate (23) and the lower arm (21); the coupling portion (25T) coupled to the general surface portion (21B) of the lower arm (21) which is positioned out of the co-fastening portion (25S); and the load transmission portion (25U) configured to directly transmit a load input to the co-fastening portion (25S) to the coupling portion (25T).

With this configuration, the load transmitted from the reclining plate (23) to the lower arm (21) via the bolt fastening portion (20A) can be appropriately dispersed and received over a wide range of the lower arm (21) by the reinforcing member (25).

Further, the reinforcing member (25) includes: the bottom surface covering portion (25A) covering the bottom surface portion (21A) of the lower arm (21); the both side surface covering portions (25B) connected to the bottom surface covering portion (25A) and covering the both side surface portions (21B) of the lower arm (21); and the rear surface covering portion (25C) connected to the both side surface covering portions (25b) and the bottom surface covering portion (25A) and covering the rear surface portion of the lower arm (21). With this configuration, the strength against the upward bending of the lower arm (21) can be more appropriately enhanced by the reinforcing member (25). Further, the bending deformation of the both side surface portions (21B) of each lower arm (21) in the seat width direction can be appropriately suppressed by the both side surface covering portions (25B) connected to the bottom surface covering portion (25A) and the rear surface covering portion (25C) of the reinforcing member (25).

Further, the vehicle seat (1) further includes: the rear surface coupling portion (25W) integrally coupling the rear surface covering portion (25C) with the lower arm (21). With this configuration, the strength against the upward bending of the rear portion of the lower arm (21) can be more appropriately enhanced by the reinforcing member (25), and the load transmitted to the lower arm (21) can be appropriately dispersed and received over a wide range of the lower arm (21) via the reinforcing member (25).

Further, the reinforcing member (25) is made of fiber-reinforced plastic. When the reinforcing member (25) is made of fiber-reinforced plastic with high specific strength in this manner, it is possible to appropriately reinforce the lower arm (21) without excessively increasing the weight.

Further, the seat 1 of the present embodiment has the following configurations. That is, the vehicle seat (1) includes: the reclining plate (23) connected to the recliner (30) serving as a seat reclining adjustment mechanism, and the lower arm (21) serving as the side frame of the seat cushion (3). A rear region of the lower arm (21) is coupled to the reclining plate (23). The vehicle seat (1) includes: the front leg (24F) and the rear leg (24R) supporting the lower arm (21) in a state where the lower arm (21) is raised with respect to the base (FB) on the floor (F) at two positions in the front and rear direction; and the pin joining portion (24Rb) including the single shaft member (B) which penetrates through the rear leg (24R) and the reclining plate (23) in the seat width direction to join the rear leg (24R) and the reclining plate (23) in a relatively rotatable manner.

With this configuration, the load transmitted from the reclining plate (23) to the lower arm (21) can be transmitted to the support point (24Fb) by the front leg (24F) by the rotation of the lower arm (21) around the pin joining portion (24Rb) between the reclining plate (23) and the rear leg (24R), and the load input to the lower arm (21) can be appropriately dispersed and escaped.

Further, the shaft member (B) is a bolt which penetrates through the reclining plate (23) and the lower arm (21) in the seat width direction so as to fasten the reclining plate (23) and the lower arm (21), and the rear leg (24R) is fastened together with the reclining plate (23) and the lower arm (21) via the shaft member (B). With this configuration, the load can be more appropriately dispersed and transmitted from the reclining plate (23) to the lower arm (21) via the shaft member (B).

Further, the lower arm (21) includes the closed sectional portion (21D) having a closed sectional shape, and the shaft member (B) penetrates through both side surface portions (21B) of the closed sectional portion (21D) so as to fasten the reclining plate (23) and the lower arm (21). With this configuration, the shaft member (B) can be provided in a state of being axially supported with respect to the lower arm (21) at two positions separated in the seat width direction, and the load can be more appropriately dispersed and transmitted from the reclining plate (23) to the lower arm (21) via the shaft member (B).

Further, the seat 1 of the present embodiment has the following configurations. That is, the vehicle seat (1) includes: the frame member (21) having the plurality of insertion holes (21R) into which the plurality of shaft portions of the plurality of bolts (B) are respectively inserted; and the plurality of collar portions (26A) which are respectively aligned with the plurality of insertion holes (21R) of the frame member (21) and through which the plurality of shaft portions of the plurality of bolts (B) respectively passes. The plurality of collar portions (26A) is configured as a collar body (26) which is a single component and in which the collar portions (26) are joined with each other into one piece.

Since the plurality of collar portions (26A) through which the plurality of shaft portions of the plurality of bolts (B) inserted into the frame member (21) respectively passes are configured as the collar body (26) which is a single component and in which the collar portions (26A) are joined into one piece, the collar portions (26A) can be collectively positioned, thereby improving the assembling property.

Further, the frame member (21) includes the pair of facing portions (21B) facing each other. The plurality of insertion holes (21R) penetrates the pair of facing portions (21B). The collar body (26) is arranged between the pair of facing portions (21B). With this configuration, the collar portions (26) of the collar body (26) joined with each other into one piece can be easily positioned by being collectively inserted between the pair of facing portions (21B) of the frame member (21).

Further, the collar body (26) has a constant sectional shape in the insertion direction of the shaft portion of the bolt (B). With this configuration, the collar body (26) can be formed by a simple molding method capable of molding a uniform sectional shape, such as extrusion molding.

Further, each of the plurality of through-holes (26B) of the plurality of collar portions (26A), through which the plurality of shaft portions of the plurality of bolts (B) passes through, respectively, penetrates through the collar portion (26A) in a constant sectional shape in the insertion direction of the shaft portion of the bolt (B). With this configuration, the through-holes (26B) of the collar body (26) can be reasonably formed by a simple molding method capable of molding a uniform sectional shape, such as the extrusion molding of the collar body (26).

Further, the frame member (21) includes the lower arm (21) which serves as the side frame of the seat cushion (3). A rear region of the lower arm (21) is fastened with the reclining plate (23) by at least one of the plurality of bolts (B). The reclining plate (23) is connected to the recliner (30) serving as a seat reclining adjustment mechanism. With this configuration, the load transmitted from the reclining plate (23) to the frame member (21) via the fastening portions of the at least one of the plurality of bolts (B) can be widely dispersed and received by the collar body (26) being joined into one piece.

Further, the frame member (21) includes the closed sectional portion (21D) having a closed sectional shape, and the collar body (26) is arranged in the closed sectional portion (21D). With this configuration, even when the collar portions (26A) are arranged in the closed sectional portion (21D) of the frame member (21), the collar portions (26A) can be simply positioned by being collectively inserted in the closed sectional portion (21D).

### OTHER EMBODIMENTS

Although the embodiments of the disclosure have been described using one embodiment, the disclosure can be implemented in various forms other than the above embodiment. For example, the structure of the vehicle seat of the disclosure can be widely applied to the seats provided for various vehicles other than automobiles, such as trains, aircrafts and ships. Further, the structure of the disclosure can be applied not only to a seat for a single person but also a seat for a plurality of passengers such as a bench seat.

Further, the lower arm may be made of a frame member having an open sectional shape, in addition to the frame member having the closed sectional shape as described in the above embodiment. Further, when the lower arm is made of the frame member having the closed sectional shape, the bolt fastening the lower arm and the reclining plate need not necessarily penetrate entirely through the closed sectional shape of the lower arm, but may be fastened through only one side of the lower arm.

Further, the reinforcing member may be made of another metal material such as aluminum material or steel material or may be made of resin material, in addition to the fiber-reinforced plastic. Further, the coupling portion of the reinforcing member coupled to the general surface portion of the lower arm may be a portion other than the side portion, such as the bottom surface portion or the upper surface portion of the lower arm. Further, when the lower arm is formed into a shape having a rear surface portion, the rear surface covering portion of the reinforcing member may be directly joined to the rear surface portion of the lower arm according to the shape of the lower arm. However, when the lower arm has the closed sectional shape as in the above embodiment, the rear surface covering portion of the reinforcing member may be indirectly joined to the lower arm via a separate member such as a collar body integrally provided in the closed sectional portion.

Further, similar to the rear leg, the coupling structure of the front leg to the lower arm may be joined in a relatively rotatable manner by the single shaft member inserted therethrough in the seat width direction. Here, the coupling structure may be integrally rigidly joined. The shaft member may be configured by a shaft member such as a pin having no fastening structure, in addition to a bolt having a fastening structure. Further, the front leg and the rear leg may be configured integrally with each other or may be configured separately from each other.

Further, the frame member may be a rail member of a slide rail for adjusting the position of the seat in the front and rear direction or a frame member constituting another seat frame, in addition to the lower arm serving as the side frame of the seat cushion previously described in the above embodiment. The frame member may be made of a frame member having an open sectional shape, in addition to the frame member having the closed sectional shape. Further, when the frame member is made of a frame member having the closed sectional shape, the bolts inserted into the insertion holes formed in the frame member may not necessarily penetrate entirely through the closed sectional shape of the frame member, but may be fastened through only one side of the frame member. Further, the frame member may be formed in a U-shaped cross section to have a pair of facing portions facing each other, where a plurality of insertion holes penetrates the pair of facing portions. At this time, the insertion hole formed to one of the pair of facing portions face the insertion hole formed to the other of the pair of facing portions.

Further, the collar body may have a sectional shape which is constant in a direction different from the insertion direction of the shaft portions of the bolts. Even with this configuration, a collar body which is a single component and in which a plurality of collar portions are joined with each other into one piece may be formed by forming the collar body using a molding method capable of molding a uniform sectional shape, such as extrusion molding, and then, separately drilling and forming a plurality of insertion holes. Further, each insertion hole of the collar body may have a hole shape other than a round hole shape, such as a rectangular hole.

What is claimed is:

1. A vehicle seat comprising:
a reclining plate connected to a recliner serving as a seat reclining adjustment mechanism;
a lower arm serving as a side frame of a seat cushion, a rear region of the lower arm being coupled to the reclining plate;
a leg supporting the lower arm in a state where the lower arm is raised with respect to a base on a floor;
a reinforcing member coupled to the lower arm and reinforcing the lower arm; and
a bolt fastening portion including a bolt which penetrates through the reclining plate and the lower arm in a seat width direction to fasten the reclining plate and the lower arm,
wherein the reinforcing member includes:
a co-fastening portion into which the bolt of the bolt fastening portion is inserted in the seat width direction so as to be fastened together with the reclining plate and the lower arm;
a coupling portion coupled to a general surface portion of the lower arm which is positioned out of the co-fastening portion; and
a load transmission portion configured to directly transmit a load input to the co-fastening portion to the coupling portion.

2. The vehicle seat according to claim 1,
wherein the reinforcing member includes:
a bottom surface covering portion covering a bottom surface portion of the lower arm;
both side surface covering portions connected to the bottom surface covering portion and covering both side surface portions of the lower arm; and
a rear surface covering portion connected to the both side surface covering portions and the bottom surface covering portion and covering a rear surface portion of the lower arm.

3. The vehicle seat according to claim 2, further comprising:
a rear surface coupling portion integrally coupling the rear surface covering portion with the lower arm.

4. The vehicle seat according to claim 1,
wherein the reinforcing member is made of fiber-reinforced plastic.

5. A vehicle seat comprising:
a reclining plate connected to a recliner serving as a seat reclining adjustment mechanism;
a lower arm serving as a side frame of a seat cushion, a rear region of the lower arm being coupled to the reclining plate;
a front leg and a rear leg supporting the lower arm in a state where the lower arm is raised with respect to a base on a floor at two positions in a front and rear direction; and
a pin joining portion including a single shaft member which penetrates through the rear leg and the reclining plate in a seat width direction to join the rear leg and the reclining plate in a relatively rotatable manner.

6. The vehicle seat according to claim 5,
wherein the shaft member is a bolt which penetrates through the reclining plate and the lower arm in the seat width direction so as to fasten the reclining plate and the lower arm, and
wherein the rear leg is fastened together with the reclining plate and the lower arm via the shaft member.

7. The vehicle seat according to claim 6,
wherein the lower arm includes a closed sectional portion having a closed sectional shape, and the shaft member penetrates through both side surface portions of the closed sectional portion so as to fasten the reclining plate and the lower arm.

8. A vehicle seat comprising:
a frame member having a plurality of insertion holes into which a plurality of shaft portions of a plurality of bolts are respectively inserted; and
a plurality of collar portions which are respectively aligned with the plurality of insertion holes of the frame member and through which the plurality of shaft portions of the plurality of bolts respectively passes,
wherein the plurality of collar portions is configured as a collar body which is a single component and in which the collar portions are joined with each other into one piece.

9. The vehicle seat according to claim 8,
wherein the frame member includes a pair of facing portions facing each other, the plurality of insertion holes penetrating the pair of facing portions, and
wherein the collar body is arranged between the pair of facing portions.

10. The vehicle seat according to claim 8,
wherein the collar body has a constant sectional shape in an insertion direction of the shaft portion of the bolt.

11. The vehicle seat according to claim 10,
wherein each of a plurality of through-holes of the plurality of collar portions, through which the plurality of shaft portions of the plurality of bolts passes through, respectively, penetrates through the collar portion in a constant sectional shape in the insertion direction of the shaft portion of the bolt.

12. The vehicle seat according to claim 8,
wherein the frame member includes a lower arm which serves as a side frame of a seat cushion, a rear region of the lower arm being fastened with a reclining plate by at least one of the plurality of the bolts, and the reclining plate being connected to a recliner serving as a seat reclining adjustment mechanism.

13. The vehicle seat according to claim 8,
wherein the frame member includes a closed sectional portion having a closed sectional shape, and the collar body is arranged in the closed sectional portion.
